(19) United States
(12) Patent Application Publication
(10) Pub. No.: US 2022/0103769 A1
(43) Pub. Date: Mar. 31, 2022

(54) An Imaging Device and a Method of Enabling Rolling Shutter Image Sensor to Function as Global Shutter

(71) Applicant: Daimler AG, Stuttgart (DE)

(72) Inventors: Amit NENE, Menlo Park, CA (US); Naveen SANGENENI, Fremont, CA (US); Ridge MCGHEE, Newark, CA (US)

(21) Appl. No.: 17/428,882

(22) PCT Filed: Dec. 12, 2019
(86) PCT No.: PCT/EP2019/084987

§ 371 Date: Aug. 5, 2021

(30) Foreign Application Priority Data
Feb. 6, 2019 (DE) 10 2019 000 850.2

(51) Int. Cl. H04N 5/353; H04N 5/235

(52) U.S. Cl. CPC H04N 5/3532; H04N 5/2354; H04N 5/2353

(57) ABSTRACT

An imaging device includes an image sensor including a rolling shutter functionality, one or more lighting elements capable of generating light at a predetermined time and duration, a light control component configured to control amount of light generated by the one or more lighting elements entering the image sensor, where the light control component is disposed between the image sensor and a lens of the imaging device; and a processing unit enabling the image sensor to function as a global shutter image sensor using the light control component, to capture at least one image of a moving object by synchronizing the light control component with light generated from the one or more lighting elements.

### DESCRIPTION OF THE INVENTION

### Technical Field

The present disclosure generally relates to imaging devices and camera sensors. Particularly, but not exclusively, the disclosure provides an imaging device and a method for simulating rolling shutter camera as global shutter camera.

### Background of the Disclosure

Most of the machine vision cameras are incorporated with either rolling shutter sensors or global shutter sensors. It is known that global shutter cameras provide clear images without blur compared to rolling shutter cameras. The capability of global shutter cameras to provide a clear image with no motion blur on moving objects is because of the fact that the global shutter sensor allows all pixels to accumulate a charge with the exposure starting and ending at same time, and the charge is read out simultaneously at the end of exposure time. Though rolling shutter cameras are cheaper, the images of moving objects produced by the rolling shutter cameras are skewed since the pixels are processed one row at a time. Due to the large image format and complicated circuits, the cost of lens and overall global shutter camera lens is expensive.

Therefore, a cost sensitive rolling shutter camera with global shutter functionality is required.

In traditional or conventional methods, in order to simulate rolling shutter as global shutter while strobing the lights, a perfectly dark room is required. Any addition of ambient light during the tests add to distortion. Existing techniques use a ‘global reset’ function in which all rows begin integrating at the same time, but end at different times. With the use of ‘global reset’, a flash of light that ends when the first row is entirely captured ensures that the final image is un-skewed. However, this must be executed in a very dark environment so as not to get less bright ghost images from the remaining rows. Thus, global reset is not practical in an automotive or industrial environment where presence of ambient light is unavoidable. Also, the flashes of light are often synchronized with the camera's framerate, causing a strobe effect that is distracting or dangerous to health.

The information disclosed in this background of the disclosure section is only for enhancement of understanding of the general background of the invention and should not be taken as an acknowledgement or any form of suggestion that this information forms the prior art already known to a person skilled in the art.

### SUMMARY OF THE DISCLOSURE

Before the present method, apparatus and hardware enablement's are described, it is to be understood that this invention is not limited to the particular systems, and methodologies described, as there can be multiple possible embodiments of the present invention which are not expressly illustrated in the present disclosure. It is also to be understood that the terminology used in the description is for the purpose of describing the particular versions or embodiments only, and is not intended to limit the scope of the present invention which will be limited only by the appended claims.

In one embodiment, the present disclosure relates to an imaging device. The disclosed device comprises an image sensor including a rolling shutter functionality and one or more lighting elements capable of generating light at a predetermined time and duration. The disclosed device further comprises a light control component configured to control amount of light generated by the one or more lighting elements entering the image sensor. In an aspect, the light control component is arranged between the image sensor and lens of the imaging device. The device as disclosed further comprises a processing unit configured to enable the image sensor to function as a global shutter image sensor using the light control component, to capture at least one image of a moving object by synchronizing the light control component with the light generated by the one or more lighting elements.

In another embodiment, the present disclosure relates to a method of enabling an image sensor including a rolling shutter functionality to function as a global shutter image sensor. In an aspect, the method comprises steps of receiving an electrical pulse applied on an external shutter of an imaging device. Based on the electrical pulse, the method enables synchronization of a light control component with a light generated by one or more lighting elements. The disclosed method further comprises controlling amount of light entering the image sensor using the light control component at a predetermined time and duration and enabling the image sensor to capture at least one image of a moving object when light enters the image sensor.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

The novel features and characteristic of the disclosure are set forth in the app ended claims. The disclosure itself, however, as well as a preferred mode of use, further objectives and advantages thereof, will best be understood by reference to the following detailed description of an illustrative embodiment when read in conjunction with the accompanying drawings. One or more embodiments are now described, by way of example only, with reference to the accompanying drawings wherein like reference numerals represent like elements and in which:

FIG. 1a illustrates an exemplary block diagram of an imaging device implemented for functioning an image sensor with rolling shutter functionality as a global shutter image sensor in accordance with some embodiments of the present disclosure;

FIG. 1b shows an illustrative example of the imaging device along with additional setup in accordance with some embodiments od the present disclosure;

FIG. 2 is a diagram illustrating a schematic setup of the imaging device for enabling an image sensor with rolling shutter functionality to function as a global shutter image sensor in accordance with an embodiment of the present disclosure; and

FIG. 3 shows a flowchart illustrating a method of enabling the image sensor including rolling shutter functionality to function as the global shutter image sensor in accordance with an embodiment of the present disclosure.

The figures depict embodiments of the disclosure for purposes of illustration only. One skilled in the art will readily recognize from the following description that alternative embodiments of the structures and methods illustrated herein may be employed without departing from the principles of the disclosure described herein.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

The terms “includes”, “including”, or any other variations thereof, are intended to cover a non-exclusive inclusion, such that a setup, device or method that includes a list of components or steps does not include only those components or steps but may include other components or steps not expressly listed or inherent to such setup or device or method. In other words, one or more elements in a system or apparatus proceeded by “includes . . . a” does not, without more constraints, preclude the existence of other elements or additional elements in the system or method.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

Present disclosure teaches an imaging device comprising an image sensor with rolling shutter functionality configured to function as a global shutter image sensor. The image sensor can be configured to function as the global shutter image sensor by controlling amount of light entering the imaging sensor. The imaging device comprises one or more lighting elements capable of generating light at a predetermined time and duration, and a light control component configured to control amount of light entering the image sensor. The light control component is arranged between the image sensor and lens of the imaging device and is synchronized with the light generated from one or more lighting elements allowing light into the image sensor at the predetermined time and duration. When an electrical pulse is applied on an external shutter of the imaging device, the light control component is triggered to allow light to enter the image sensor for the predetermined duration and to block the light entering the image sensor after the predetermined duration, thereby controlling lighting of the image sensor. By proposed device and method, a cost-effective solution for minimizing detrimental effects of strobe lighting on attention and health is achieved.

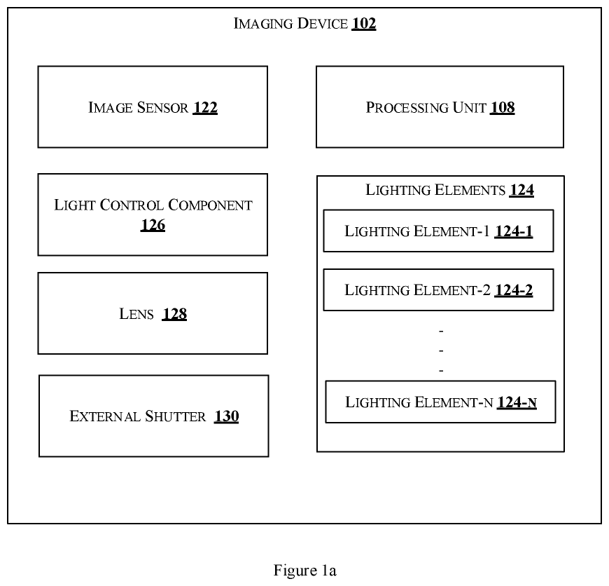

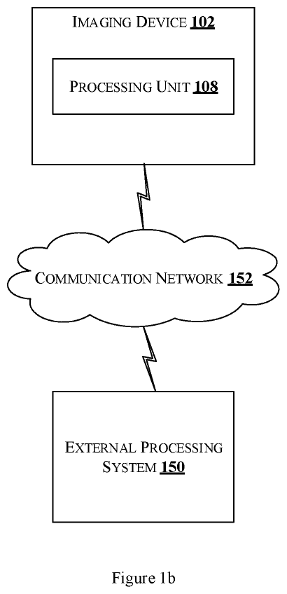

FIG. 1a shows an exemplary block diagram of an imaging device implemented for functioning an image sensor with rolling shutter functionality as a global shutter image sensor in accordance with some embodiments of the present disclosure. As shown in the FIG. 1a, the imaging device 102 may comprise a processing unit 108, an image sensor 122, one or more lighting elements 124-1, 124-2, . . . 124-N (collectively referred to as lighting elements 124), a light control component 126, lens 128 and an external shutter 130.

The image sensor 122 may be, for example, a rolling shutter image sensor or a rolling shutter camera, capable of capturing one or more images. The image sensor 122 may be capable of capturing images in any file format such as Joint photographic experts group (JPEG), Graphics interchange format (GIF), Standards for bitmap (BMP), Tagged image file format (TIFF) and other common file format used for images that can be converted to any suitable format before processing the images.

The one or more lighting elements 124 shown in FIG. 1a may be any electrical circuit or device capable of generating light. In one example, the lighting elements 124 may be light emitting diode (LED) strips capable of producing regular flashes of light. Further, the lighting elements 124 may be operable to connect to element drivers that regulates the power required for lighting elements 124. Furthermore, the lighting elements 124 may be operable to connect to processing unit 108 for synchronizing the light generated by the lighting elements 124 with the light control component 126.

The light control component 126 of the imaging device 102 shown in FIG. 1a is capable of controlling amount of light entering the image sensor 122. The light control component 126 is arranged between the image sensor 122 and lens 128 of the imaging device 102. In one embodiment, the light control component 126 may be an electronic shutter configured to synchronize with the light generated from the lighting elements 124 thereby allowing light to enter the image sensor at a predetermined time and duration. For example, the electronic shutter may be a Liquid Crystal (LC) shutter that has a single large pixel that covers entire viewable area. The LC shutter is capable to turn into one of transparent and opaque based on instructions from the processing unit 108. In another embodiment, the light control component 126 may be a member comprising a rotating disc that allows light to enter into the image sensor at the predetermined time and duration. In one example, the member may be a mechanical device that is configured to open and close an aperture based on instructions from the processing unit 108. The ON mode may be defined, in one example, as operational mode that enables certain amount of light to enter the image sensor 122 at a predetermined time and duration. The OFF mode may be defined, in one example, as an idle mode that stops or blocks the light entering the image sensor 122 after completion of the predetermined duration at the predetermined time.

The lens 128 is an optical lens or an assembly of lenses used in conjunction with the image sensor. For example, the lens 128 shown in FIG. 1a may be a machine vision camera lenses such as C-mount lens that are compatible with Charge Coupled Device (CCD) and Complementary Metal-Oxide Semiconductor (CMOS) cameras. In the imaging device 102 described in this disclosure, the light control component 126 is arranged adjacent to the lens 128, to enable control of lighting onto the image sensor 122. In one embodiment, the light control component 126 is arranged behind the lens 128.

The external shutter 130 depicted in FIG. 1a, in one example, may be a shutter release button or a push button arranged external to the components of the imaging device 102. Further, the external shutter 130 is capable of receiving electrical pulse and enabling capture of one or more images based on the electrical pulse.

The processing unit 108 illustrated in FIG. 1a may be any processor or a microcontroller capable of performing one or more instructions. The one or more instructions on execution may cause the image sensor 122 including the rolling shutter functionality to function as a global shutter image sensor. In one embodiment, the processing unit 108 is configured to enable the image sensor 122 to capture one or more images of moving object without blur or distortion and achieve an image quality similar to an image captured by the global shutter image sensor. To achieve the objective of the disclosure, the processing unit 108 controls the amount of light entering the image sensor 122 by synchronizing the light control component 126 with the light generated from the lighting elements 124.

Initially, for capturing the one or more images of moving object using the imaging device 102 of the disclosure, an exposure time or the predetermined duration and time is defined based on one or more parameters such as shutter speed, frequency of the lighting elements 124 and so on. In operation, when the capture of image is initiated, the electrical pulse is applied on the external shutter 130 of the imaging device 102. The processing unit 108 receives the electrical pulse and enables the lighting elements 124 to generate the light. Subsequently, the processing unit 108 synchronizes the light control component 126 with the light generated by the lighting elements 124 allowing the light to enter into the image sensor 122 at the predetermined time and duration. In one embodiment, the processing unit 108 enables the light control component 126, for example the electronic LC shutter, to operate in ON mode at the predetermined time and duration when a trigger of electrical pulse is received. The LC shutter turns transparent in ON mode and allows light to enter into the image sensor 122 at the predetermined time and duration. After the predetermined duration, the LC shutter operates in OFF mode turning opaque and blocks the light entering the image sensor 122. The amount of lighting is thus controlled using the LC shutter.

In another embodiment, the processing unit 108 enables the light control component 126, for example the member comprising the rotating disc, to open when the trigger of electrical pulse is received allowing the light to enter into the image sensor 122 for the predetermined time and duration. The member, in one example, may be the mechanical device comprising the rotating disc that switches to open position to allow light to enter the image sensor 122 for the predetermined time and duration. After the predetermined duration, the mechanical device switches to close position blocking the light to enter the image sensor 122. The lighting on the image sensor 122 is thus controlled using the light control component 126 which enables the image sensor 122 to capture images of moving object without blur.

Further, the processing unit 108 is configured to enable the image sensor 122 to capture the at least one image of the moving object when the light enters the image sensor 122 and stops capturing the at least one image when the light is blocked from entering the image sensor 122.

It may be noted that the imaging device 102 may be implemented particularly, but not limited to, capturing one or more images of moving objects. In an embodiment, the imaging device 102 may be operatively coupled to an external processing system 150 as illustrated in FIG. 1b in accordance with an embodiment of the present disclosure. The imaging device 102 may be connected to the external processing system 150 via a communication network 152. The communication network 152 may include, without limitation, a direct interconnection, Control Area Network (CAN), Local Area Network (LAN), Wide Area Network (WAN), wireless network (e.g., using Wireless Application Protocol), the Internet, and the like.

The external processing system 150 is configured to perform one or more of image recognition, object detection, image classification and other related techniques by processing one or more images captured by the image sensor 122. In one embodiment, the processing unit 108 may be configured to transmit or send one or more images captured by the image sensor 122 to the external processing system 150. In one example, the one or more images received by the external processing system 150 may be stored in an internal memory of the external processing system 150. In another example, the one or more images received by the external processing system 150 may be stored in a server that may be operable to connect to various devices for transferring any information stored thereon to the devices.

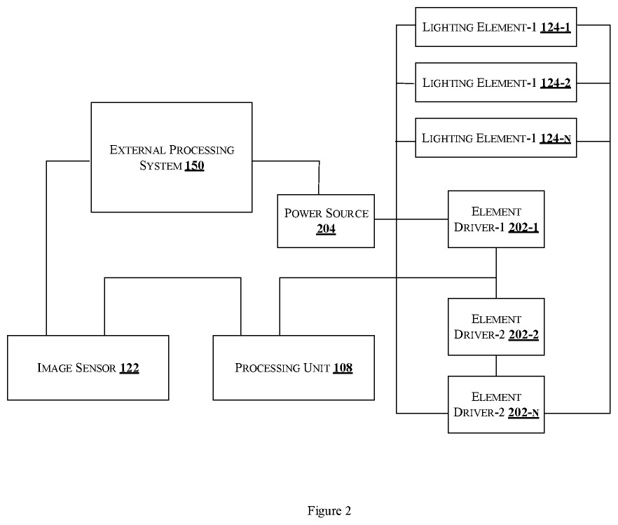

FIG. 2 is a diagram illustrating a schematic setup of the imaging device 102 for functioning an image sensor 122 with rolling shutter functionality as a global shutter image sensor in accordance with an embodiment of the present disclosure. The one or more lighting elements 124-1, 124-2, . . . 124-N of the imaging device 102 are operatively coupled with element driver-1 202-1, element driver-2 202-2, . . . element driver-N 202-N (collectively referred to as element drivers 202) as shown in FIG. 2 to regulate power required for lighting elements 124 using known power regulation or voltage regulation techniques. Further, the element drivers 202 and the external processing system 202 is connected to a power source 204. The power source 204 may be capable of supplying variable power sensor for components of the imaging device 102.

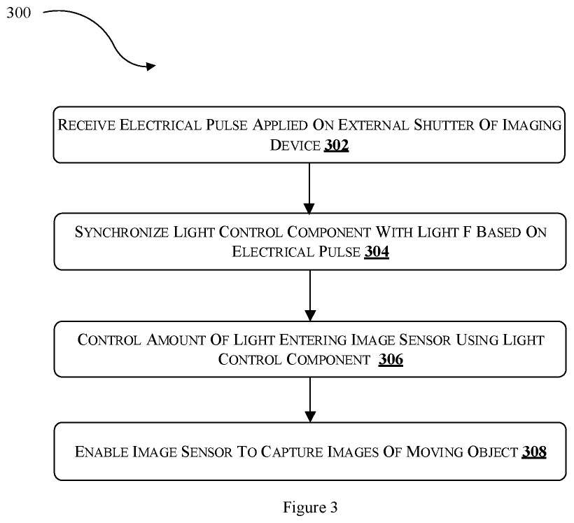

FIG. 3 shows a flowchart illustrating a method for enabling the image sensor including rolling shutter functionality to function as the global shutter image sensor in accordance with an embodiment of the present disclosure;

At block 302, electrical pulse applied on external shutter of the imaging device 102 is received. In one embodiment, the processing unit 108 receives the electrical pulse applied on the external shutter of the imaging device 102.

At block 304, the light control component 126 is synchronized with the light generated from the lighting elements 124. In one embodiment, the processing unit 108 synchronizes the light control component 126 with the light generated by the lighting elements 124 upon receiving the electrical pulse, to allow the light to enter into the image sensor 122 at the predetermined time and duration.

At block 306, the amount of light entering the image sensor is controlled. In one embodiment, the processing unit 108 enables the light control component 126, for example the electronic LC shutter, to operate in ON mode at the predetermined time and duration when a trigger of electrical pulse is received. The LC shutter turns transparent in ON mode and allows light to enter into the image sensor 122 at the predetermined time and duration. After the predetermined duration, the LC shutter operates in OFF mode turning opaque and blocks the light entering the image sensor 122. In another embodiment, the processing unit 108 enables the light control component 126, for example the member, to open when the trigger of electrical pulse is received allowing the light to enter into the image sensor 122 for the predetermined time and duration. The member, in one example, may be the mechanical device comprising the rotating disc that switches to open position to allow light to enter the image sensor 122 for the predetermined time and duration. After the predetermined duration, the mechanical device switches to close position blocking the light to enter the image sensor 122. The lighting on the image sensor 122 is thus controlled using the light control component 126 which enables the image sensor 122 to capture images of moving object without blur.

At block 308, the image sensor 122 is enabled to capture images of moving objects. In one embodiment, the processing unit 108 is configured to enable the image sensor 122 to capture the at least one image of the moving object when the light enters the image sensor 122 and stops capturing the at least one image when the light is blocked to enter the image sensor 122.

As illustrated in FIG. 3, the method 300 may include one or more blocks for executing processes by the processing unit 108. The method 300 may be described in the general context of computer executable instructions. Generally, computer executable instructions can include routines, programs, objects, components, data structures, procedures, modules, and functions, which perform particular functions or implement particular abstract data types.

The order in which the method 300 is described may not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

It may be clear to those skilled in the art the presently disclosed system and method may be used either independently or in combination with existing technologies being implemented for vehicular cargo space management.

While various aspects and embodiments have been disclosed herein, other aspects and embodiments will be apparent to those skilled in the art. It may be pertinent to note that various aspects and embodiments disclosed herein are for purposes of illustration and are not intended to be limiting, with the true scope being indicated by the following claims.

1.-10. (canceled)

11. An imaging device, comprising:
an image sensor including a rolling shutter functionality;
one or more lighting elements capable of generating light at a predetermined time and duration;
a light control component configured to control amount of light generated by the one or more lighting elements entering the image sensor, wherein the light control component is disposed between the image sensor and a lens of the imaging device; and
a processing unit enabling the image sensor to function as a global shutter image sensor using the light control component, to capture at least one image of a moving object by synchronizing the light control component with light generated from the one or more lighting elements.

12. The imaging device as claimed in claim 11, wherein the processing unit is configured to enable the light control component to allow light into the image sensor at the predetermined time and the duration.

13. The imaging device as claimed in claim 11, wherein the light control component is an electronic shutter synchronized with the light configured to operate in at least one of ON mode and OFF mode.

14. The imaging device a claimed in claim 13, wherein the electronic shutter is a Liquid crystal shutter configured to turn transparent in ON mode when an electrical pulse is applied on an external shutter of the imaging device allowing light to enter the image sensor at the predetermined time and the duration, and turn opaque in OFF mode after the predetermined duration by blocking the light to enter the image sensor.

15. The imaging device as claimed in claim 11, wherein the light control component is a member comprising a rotating disc that allows light to enter into the image sensor at the predetermined time and duration.

16. The imaging device as claimed in claim 11, wherein the processing unit is configured to enable the image sensor to capture the at least one image when the light enters the image sensor.

17. A method of enabling an image sensor including rolling shutter functionality to function as a global shutter image sensor, comprising the steps of:
receiving an electrical pulse applied on an external shutter of an imaging device;
synchronizing a light control component with a light generated by one or more lighting elements based on the electrical pulse;
controlling amount of light entering the image sensor using the light control component at a predetermined time and duration; and
enabling the image sensor to capture at least one image of a moving object when light enters the image sensor.

18. The method as claimed in claim 17, wherein the light control component synchronized with the light is an electronic shutter disposed between a lens of the imaging device and the image sensor, configured to operate in at least one of ON mode and OFF mode.

19. The method as claimed in claim 17, wherein controlling the amount of light entering the image sensor comprises steps of:
enabling the light control component to operate in ON mode when the electrical pulse is applied, wherein the light control component turns transparent at the predetermined time and the duration allowing light to enter the image sensor; and
enabling the light control component to operate in OFF mode after the predetermined duration, wherein the light control component turns opaque by stopping light to enter the image sensor.

20. The method as claimed in claim 17, wherein the light control component is a member comprising a rotating disc that allows light to enter into the image sensor at the predetermined time and the duration.
